(19) United States
(12) Patent Application Publication
(10) Pub. No.: US 2025/0266899 A1
(43) Pub. Date: Aug. 21, 2025

(54) AUTOMATIC AIRBORNE REMOTE AREA EMERGENCY SYSTEM

(71) Applicant: SAUDI ARABIAN OIL COMPANY, Dhahran (SA)

(72) Inventors: Hassan Althani, Al Mubarraz (SA); Anas Bahatheq, Dhahran (SA); Naif Anazi, Al Mubarraz (SA)

(73) Assignee: SAUDI ARABIAN OIL COMPANY, Dhahran (SA)

(21) Appl. No.: 18/581,081

(22) Filed: Feb. 19, 2024

(51) Int. Cl. H04B 7/185; B64B 1/50; B64U 10/30; B64U 10/60; B64U 101/23; H04W 4/90; H04W 24/04; H04W 84/04

(52) U.S. Cl. CPC H04B 7/18504; B64B 1/50; B64U 10/30; B64U 10/60; H04W 4/90; H04W 24/04; B64U 2101/23; H04W 84/047

(57) ABSTRACT

A method for boosting telecommunication signals is used to mitigate a pre-determined adverse event. The method includes disposing a signal booster in a location where the telecommunication signals are intermittent or below a pre-determined threshold, monitoring the telecommunication signals in the location, detecting, in response to monitoring and based at least on a status of the monitored telecommunication signals, the pre-determined adverse event, elevating, using air lift and in response to detecting the pre-determined adverse event, the signal booster to an elevated height, receiving and re-broadcasting, by the signal booster from the elevated height, the telecommunication signals, and mitigating, based at least on the re-broadcasted telecommunication signals, the pre-determined adverse event.

### BACKGROUND

Current mobile device telecommunication service (e.g., cellular service) coverage is concentrated around populated areas while remote areas have weak signals affected by the area topography. This imposes challenging and risky site operations where unavailability of mobile telecommunication service coverage increases the severity and fatality in emergency situations. Oil and gas industry has many operations and construction activities that involve employees and contractors traveling in remote areas such as deserts having poor mobile telecommunication service coverage. Due to enormous size and complexity of the operations and treacherous remote environment, the risk (i.e., likelihood and impact) of people getting stuck in sandy desert area is more pronounced than any other place. The incidents are historically fatal and have long lasting physiological effects on the survivors. For example, according to the statistics, there are more than 6000 deaths in the remote areas around the world in the year 2022 that led to significant expenses in rescue operations.

### SUMMARY

In general, in one aspect, the invention relates to a method for boosting telecommunication signals. The method includes disposing a signal booster in a location where the telecommunication signals are intermittent or below a pre-determined threshold, monitoring the telecommunication signals in the location, detecting, in response to said monitoring and based at least on a status of the monitored telecommunication signals, a pre-determined adverse event, elevating, using air lift and in response to said detecting the pre-determined adverse event, the signal booster to an elevated height, receiving and re-broadcasting, by the signal booster from the elevated height, the telecommunication signals, and mitigating, based at least on the re-broadcasted telecommunication signals, the pre-determined adverse event.

In general, in one aspect, the invention relates to a system for boosting telecommunication signals. The system includes a signal booster disposed in a location where the telecommunication signals are intermittent or below a pre-determined threshold, a controller that monitors the telecommunication signals in the location, and detects, in response to said monitoring and based at least on a status of the monitored telecommunication signals, a pre-determined adverse event. And an airborne component that carries, using air lift and in response to said detecting the pre-determined adverse event, the signal booster to an elevated height, wherein the signal booster receives and re-broadcasts the telecommunication signals from the elevated height, and wherein the pre-determined adverse event is mitigated based at least on the re-broadcasted telecommunication signals.

In general, in one aspect, the invention relates to a vehicle for traveling in a remote area. The vehicle includes an automatic airborne remote area emergency system comprising a signal booster that receives and re-broadcast telecommunication signals that are intermittent or below a pre-determined threshold in the remote area, a controller that monitors the telecommunication signals, and detects, in response to said monitoring and based at least on a status of the monitored telecommunication signals, a pre-determined adverse event, and an airborne component that carries, using air lift and in response to said detecting the pre-determined adverse event, the signal booster to an elevated height, wherein the signal booster receives and re-broadcasts the telecommunication signals from the elevated height, and wherein the pre-determined adverse event is mitigated based at least on the re-broadcasted telecommunication signals.

Other aspects and advantages will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1A and 1B show systems in accordance with one or more embodiments.

FIG. 2 shows a flowchart in accordance with one or more embodiments.

FIG. 3 shows an example in accordance with one or more embodiments.

FIG. 4 shows a computing system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Embodiments of this disclosure provide an automatic airborne emergency system that allows remote area telecommunication and acts as an elevated emergency beacon to guide rescuers to the emergency location. The system detects emergency situations and automatically initiates rescue operations to aid a user in need, such as an unconscious victim. The system includes airborne and ground level components that are controlled by an intelligent controller. In one or more embodiments, the intelligent controller is implemented using programmable logic circuitry and is referred to as a Programable Logic Controller (PLC). The airborne component includes a lifting mechanism that uses buoyancy forces resulting from the different densities between air and carrying gas (e.g., Helium). In one or more embodiments, the airborne component includes a balloon with a reflective coating that is inflated using the carrying gas, and a signal booster and a battery that are carried in a lifting basket of the balloon. The ground level component includes an electrical winch, the PLC, a carrying gas storage can, a solenoid valve, and an interconnection wiring harness connecting to sensors and/or on-board diagnostics (OBD) port of a vehicle of the user. In addition to the system automatically detecting emergency situations by the PLC to enable automatic emergency response to rescue the user, the system can also be manually started and triggered by the user if and when the user is able to do so.

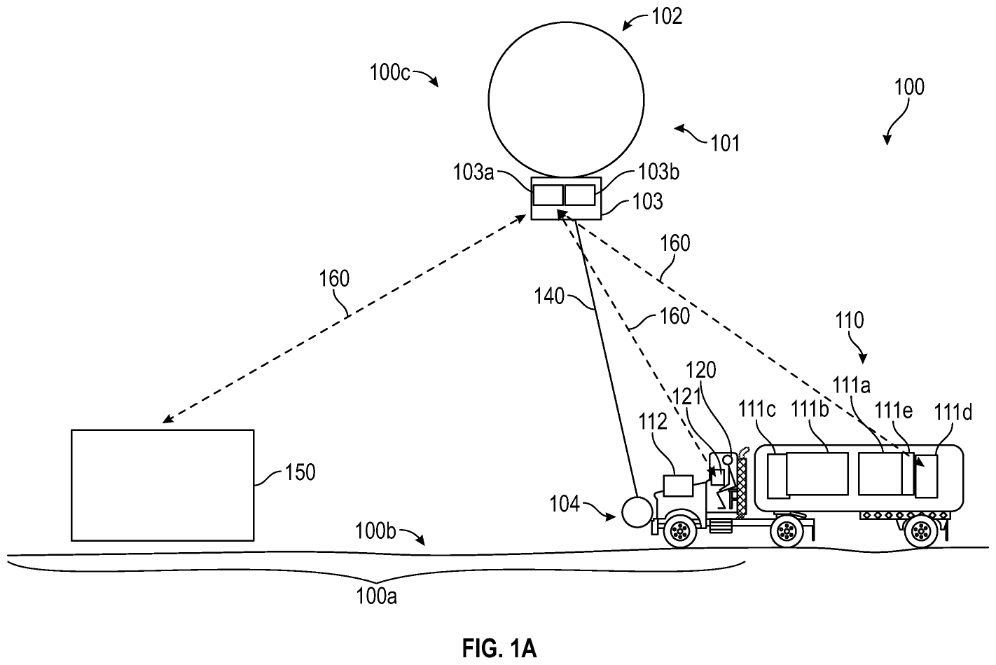

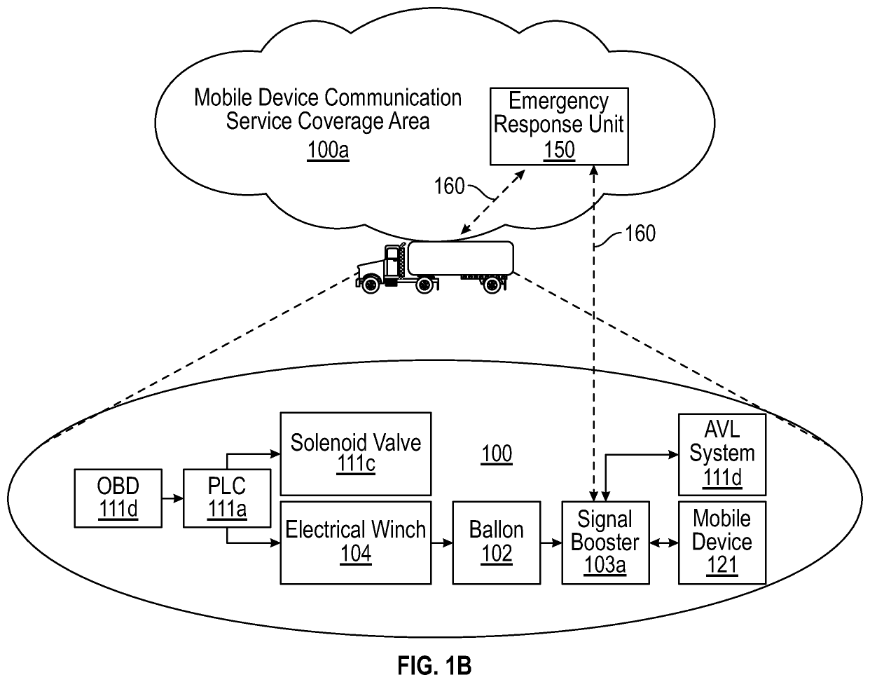

FIG. 1A shows a schematic diagram in accordance with one or more embodiments. As shown in FIG. 1A, the automatic airborne emergency system (100) includes a ground level component (110) and an airborne component (101). The airborne component (101) includes a balloon (102) with a lifting basket (103) that carries a signal booster (103a) powered by a battery (103b). The signal booster (103a) is an electronic device including hardware and/or software to receive and re-broadcast telecommunication signals. The ground level component (110) includes a storage container (112) where the airborne component (101) is stowed before being launched. To facilitate launching and retrieving the airborne component (101), the ground level component (110) is equipped with a controller (111a), a carrying gas storage tank (111b), a solenoid valve (111c), and an electric winch (104). In the scenario depicted in FIG. 1A, the ground level component (110) corresponds to a vehicle driven by a user (120) using a mobile device (121) for communication and navigation while traveling in a remote area. For example, the user (120) may be an employee or contractor for an oil and gas company, the mobile device (121) may be a cellular phone with a GPS receiver, and the vehicle may be a truck traveling in the remote land area where the mobile device telecommunication service coverage is weak or intermittent. In addition, the vehicle has a built-in automatic vehicle locating (AVL) system (111d) that uses the mobile device telecommunication service to communicate with a fleet management station of the oil and gas company. In particular, the cellular phone, GPS receiver, and AVL system may rely on telecommunication signals (160) (e.g., cellular and/or satellite signals) in the mobile device telecommunication service coverage area (100a).

When the vehicle is travelling in a fringe area, e.g., near the boundaries of the mobile device telecommunication service coverage area (100a), the telecommunication signals (160) become intermittent or unreliable at the vehicle's location. The user (120) may manually launch the balloon (102) to boost the telecommunication signals (160) to reach an emergency response unit (150) for requesting emergency response, such as sending a rescue team to the vehicle's location, i.e., the emergency location. If the user (120) becomes incapable (e.g., unconscious or otherwise incapacitated) of manually launching the balloon (102), the controller (111a) detects the emergency condition by monitoring the AVL system (111d) via the OBD port (11e) to automatically launch the balloon (102) to boost the telecommunication signals and sends an emergency alert to the emergency response unit (150) requesting emergency response. Although the description above refers to a remote land area, those skilled in the art will appreciate that the vehicle may also be a boat or other marine vehicle travelling in a remote marine environment (e.g., lake, river, ocean, etc.) where the mobile device telecommunication service may be cellular service or other telecommunication service for marine applications.

In one or more embodiments, the balloon (102) is a lifting mechanism using buoyancy forces resulting from the different density between air and carrying gas. Balloon size and material selection is determined by the connected load and desired characteristics such as reflective coating of the balloon (102) to enable high visibility to guide a rescuer to the emergency location even at low light condition, e.g., during night time or a sand storm. TABLE 1 shows parameters for determining a target balloon size.

TABLE 1

| Lifting Force | Impose Weight |
|---|---|
| FL = V(ρA − ρG)g= | FW = mg |

FL: Lifting forces
V: Balloon volume
ρA: Air density (1.127 kg/m3 @ 40 C.)
ρG: Gas density
(0.1533 for Helium at 40 C.)
g: acceleration of gravity
FW: Forces imposed by weight
m: Mass of the load (kg)
g: acceleration of gravity

Based on the above relationship and the associated parameters for air and Helium, it is determined that 97% of balloon volume is equivalent to its lifting capacity. Mass of the load is then linked directly to size or radius of the balloon as follows:

$$m = 97 \% ( \frac{4}{3} π {r}^{3} ) ,$$

where r denotes the balloon radius in meter:

$$r = \sqrt[3]{\frac{3 m}{97 \% ( 4 π )}} = \sqrt[3]{0.246 m}$$

Actual imposed load should be limited to no more than 80% of the calculated lifting capacity so that the lifting force exceeds the imposed load to allow the balloon to rise to an elevate height. An example balloon target radius of 0.75 m is appropriate for a total lifting load of 1.5 kg accordingly.

In one or more embodiments, the signal booster (103a) is a device used to amplify and re-broadcast weak telecommunication signals to established improved and better reception. For example, the signal booster (103a) may include receiving and transmitting antennas, amplifier and energy source. The signal booster (103a) is suspended from the balloon (102) to access weak signals at high elevation (100c), amplify and re-broadcasting the signals to the mobile device (121) and AVL system (111d) at ground level (i.e., low elevation (100b)) thus enable telecommunication to the emergency response unit (150).

In one or more embodiments, the battery (103b) is a power source, e.g., with capacity of 20 Ah, to power the signal booster (103a) and allow operation time of approximately 5 hours.

In one or more embodiments, the electrical winch (104) is a worm gear type electrical motor driven winch that can be disengaged to allow manual operation. Electrical motor is powered by direct current (DC) electricity provided by the vehicle's electrical system. The balloon (102) is attached to the electrical winch (104) via a light weight winch line (104a) (e.g., a fishing line) to hover above the vehicle. The light weight line (104a) enables balloon retrieval while imposing light load.

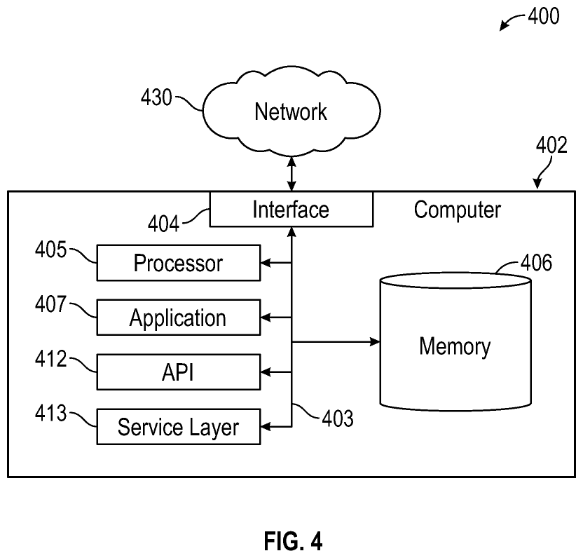

In one or more embodiments, the controller (111a) is a programmable logic controller acting as a control module that can receive data and output operating instructions via input and output ports of the controller (111a). Controller (111a) uses pre-programmed logic to process the input data and subsequently output a set of instruction to the connected equipment such as the solenoid valve (111c) and the electrical winch (104). For example, the instructions may cause the balloon (102) to be pulled out by the electrical winch (104) from the storage container (112), and cause the solenoid valve (111c) to open and inflate the balloon (102). In one or more embodiments, the controller (111a) includes a central processing unit (CPU), power supply, programming device, and input and output (I/O) modules. For example, the controller (111a) may correspond to the computer (402) depicted in FIG. 4 below.

In one or more embodiments, the carrying gas storage tank (111b) is a portable Helium tank, e.g., with size 55 cu ft to fill the balloon with a radius of 0.75 m. The carrying gas storage tank (111b) is connected via the solenoid valve (111c) to the balloon (102) until the balloon (102) is inflated to the target size to elevate, at which point the solenoid valve (111c) is closed and disconnected from the balloon (102).

Although the embodiments described above use a balloon to provide air lift for elevating the signal booster from the ground level to the elevated height, it is contemplated that a drone (i.e., an unmanned aircraft or a flying robot) may be used instead of the balloon to provide the air lift in alternative embodiments.

FIG. 1B illustrates the operation of the automatic airborne emergency system (100) depicted in FIG. 1A above. As noted above, remote areas have weak telecommunication signals affected by the area topography that increases the emergency severity and fatality. The automatic airborne emergency system (100) provides access to high elevation and establishes line of sight with a remote telecommunication tower re-establish interrupted or intermittent telecommunication for the user to request emergency rescue when needed. Once the rescuer is dispatched, reflective balloon coating effectively guides the rescuer to the emergency location using its high visibility to serve as an emergency beacon. Accordingly, the signal booster carried by the balloon acts as a multifunctional telecommunication tower to mitigate remote areas risks and significantly increase survival rate.

As shown in FIG. 1B, while the vehicle is traveling in the fringe area of the mobile device communication service coverage area (100a), the controller (111a) (e.g., a programmable logic controller or PLC) connects to the OBD port (11e) to monitor the telecommunication coverage and GPS reading via the vehicle's built-in tracking equipment such as the AVL system (111d). Once the controller (111a) detects the absence of telecommunication signals (160) for a preset time (e.g., 120 minutes), the controller (111a) generates an alert (e.g., an audio alarm or flashing warning) to the user (120) while initiating an automatic emergency response sequence that can be deactivated by the user (120) within a preset grace period (e.g., 10 minutes) to cancel the emergency response sequence to avoid unintentional emergency response activation. Once the grace period has passed or the user manually triggers the emergency response activation, the controller (111a) sends a command to open the solenoid valve (111c) thus allowing the carrying gas (e.g., helium) to inflate the balloon (102). Another command is sent to power on the signal booster (103a) and starts the electrical winch (104) to release the airborne system after a preset inflation time (e.g., 2 minute). An additional command is sent to the AVL system (111d) to transmit an emergency response request to the emergency response unit (150) once the airborne signal booster (103a) receives sufficient telecommunication signals (160) and re-broadcasts to the AVL system (111d) and the user mobile device (121).

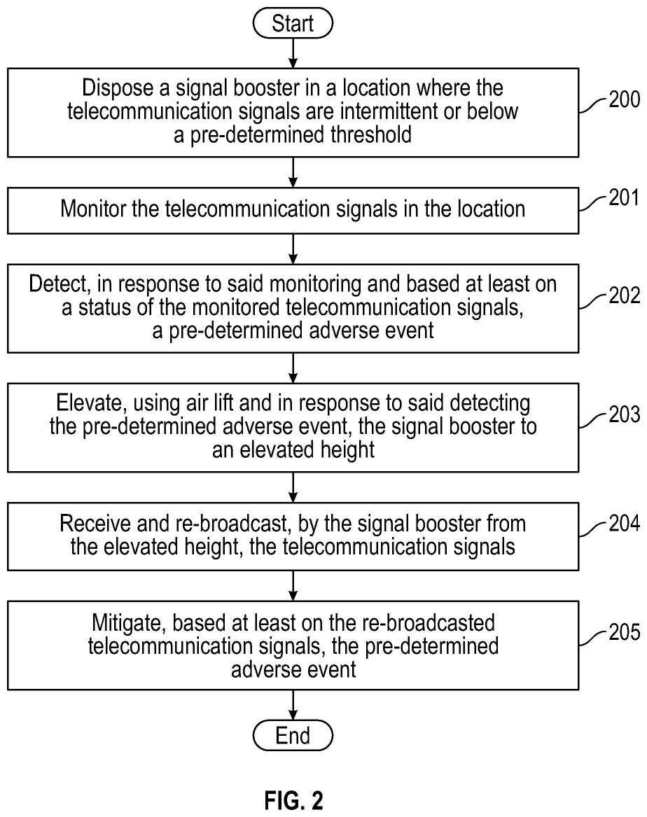

FIG. 2 shows a process flowchart in accordance with one or more embodiments. Specifically, FIG. 2 describes a method for boosting telecommunication signals. One or more blocks in FIG. 2 may be performed using one or more components as described in FIGS. 1A and 1B. While the various blocks in FIG. 2 are presented and described sequentially, one of ordinary skill in the art will appreciate that some or all of the blocks may be executed in a different order, may be combined or omitted, and some or all of the blocks may be executed in parallel and/or iteratively. Furthermore, the blocks may be performed actively or passively.

Initially in Block 200, a signal booster is disposed in a location where the telecommunication signals are intermittent or below a pre-determined threshold. In one or more embodiments, the telecommunication signals includes a cellular signal and/or a global positioning service (GPS) signal. In one or more embodiments, the signal booster is included in an automatic airborne remote area emergency system in a vehicle travelling in the location in a remote area. In particular, the signal booster is carried by a balloon or a drone stowed in a storage container on the vehicle as part of the automatic airborne remote area emergency system.

In Block 201, the telecommunication signals are monitored as the vehicle travels in a remote area. In one or more embodiments, the telecommunication signals are monitored by a controller of the automatic airborne remote area emergency system retrieving, via an on-board diagnostic (OBD) port of the vehicle, the status of the monitored telecommunication signals from an automatic vehicle locating (AVL) system on the vehicle.

In Block 202, in response to monitoring the telecommunication signals, a pre-determined adverse event is detected based on the status of the monitored telecommunication signals. For example, an adverse event may be detected based on the cellular signal strength measurement being below a minimum threshold and/or a timeout status of the GPS signal. In particular, the vehicle navigation may be compromised due to the low cellular signal strength and/or GPS signal status such that the vehicle is stranded in the remote area resulting in a dangerous situation for the vehicle driver.

In Block 203, in response to detecting the pre-determined adverse event, the signal booster is elevated using air lift to an elevated height. In one or more embodiments, the signal booster is lifted by the balloon of the automatic airborne remote area emergency system. For example, to inflate the balloon, the controller activates a solenoid valve to open and conduct a flow of carrying gas from a storage tank on the vehicle. The flow of carrying gas inflates the balloon while an electric winch on the vehicle releases the balloon from the storage container. In addition, the electric winch releases a winch line attached to the balloon to allow the balloon to elevate to the elevated height. For example, the controller disengages a braking mechanism in the electric winch such that the winch line is free to unwind from a spindle of the electric winch as the buoyancy of the balloon exerts a pulling force on the winch line.

In Block 204, as the balloon carries the signal booster to the elevated height, the signal booster receives and re-broadcasts the telecommunication signals.

In Block 205, the pre-determined adverse event is mitigated based at least on the re-broadcasted telecommunication signals. In an example scenario, the re-broadcasted telecommunication signals are sufficiently stable for necessary communication and navigation for the vehicle to travel to the destination. In another example scenario, based at least on the re-broadcasted telecommunication signals, a request for emergency response is transmitted to an emergency response unit. In response to the request, an emergency response personnel is dispatched to the remote area. In one or more embodiments, a reflective coating on the balloon at the elevated height provides visual guidance to the emergency response personnel to locate the vehicle in the remote area.

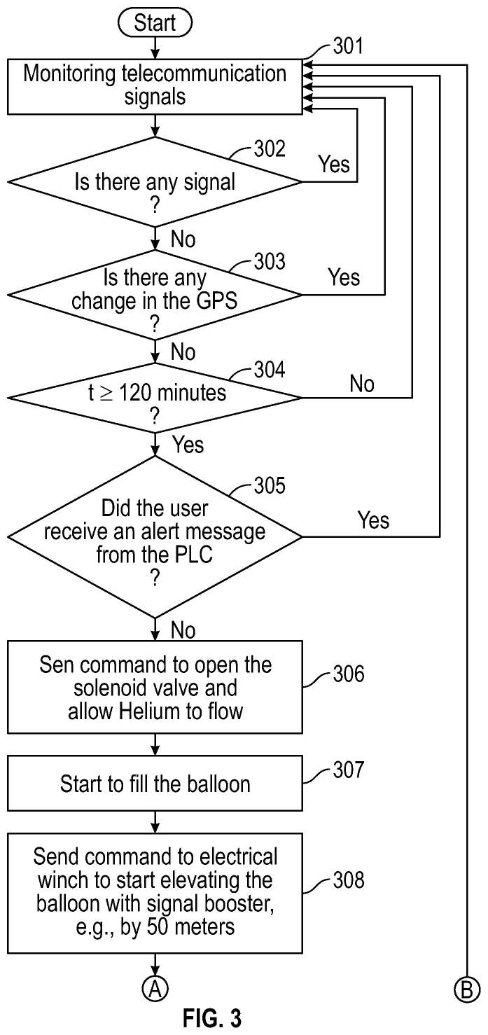

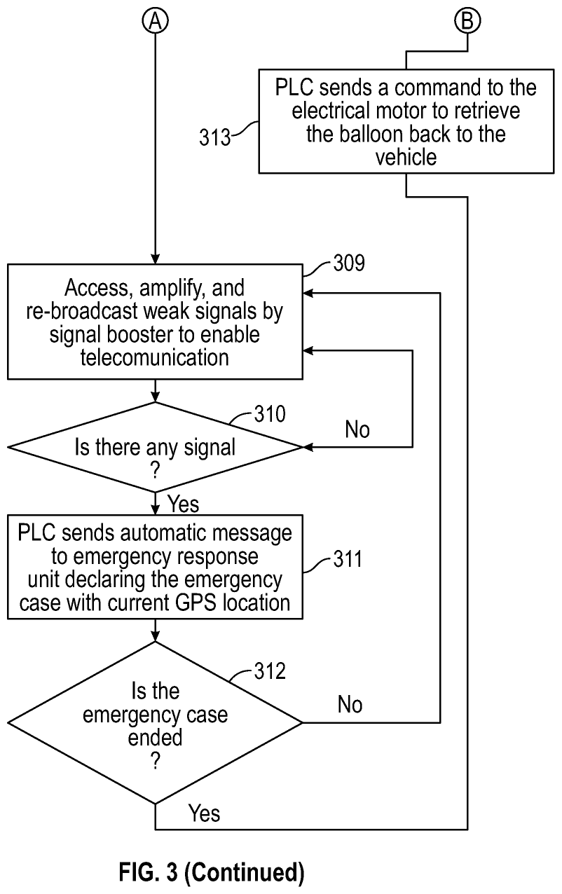

FIG. 3 shows an example in accordance with one or more embodiments. The example shown in FIG. 3 is based on the system and method described in reference to FIGS. 1A-2 above. In particular, FIG. 3 shows an example workflow to enable timely rescue operations to save lives by providing a cost-effective means of communication and automation of emergency declaration. Because remote areas are not covered by mobile telecommunication especially at ground level, access to high elevation with a clear line of sight can improve communications with the emergency responders. In one or more embodiments, one or more of the modules and/or elements shown in FIG. 3 may be omitted, repeated, combined and/or substituted. Accordingly, embodiments disclosed herein should not be considered limited to the specific arrangements of modules and/or elements shown in FIG. 3.

As shown in FIG. 3, in Block 301, the PLC of the automatic airborne remote area emergency system monitors the telecommunication and GPS signals in the area where the vehicle is traveling. For example, the PLC may obtain signal status information from the vehicle's AVL system via the OBD port. In Block 302, it is determined using the PLC whether any cellular signals are detected. If the cellular signals are present, the workflow returns to Block 301 and the PLC continues the monitoring to detect when the cellular signals may be lost. If the cellular signals are not present, the workflow proceeds to Block 303 where the PLC determines whether there is any change in the GPS location. If any change in the GPS location is detected, the workflow returns to Block 301 and the PLC continues the monitoring to determine when both cellular signals and active GPS signals may be lost. If no change in the GPS signals is detected, the workflow proceeds to Block 304 where it is determined by the PLC whether the cellular signals and GPS signals has been lost for more than an elapse time limit of 120 minutes. If the elapse time has not reached the 120 minutes limit, the workflow returns to Block 301 and the PLC continues the monitoring. If the cellular signals and any change in the GPS location have not been detected for more than the 120 minutes limit, the workflow proceeds to Block 305 where it is determined whether the user received an alert message from the PLC to the user through an interactive screen in the vehicle indicating that the emergency response sequence is about to be initiated. In particular, it is determined by the PLC whether an instruction is received from the user not to initiate any emergency response sequence. If the instruction is received, e.g., from the user's mobile device or the interactive screen not to initiate any emergency response sequence, the workflow returns to Block 301 and the PLC continues the monitoring.

If no instruction is received from the user's mobile device not to initiate any emergency response sequence, the workflow proceeds to Block 306 where the PLC sends a command to open the solenoid valve to allow the carrying gas (e.g., helium) flow. In Block 307, the balloon is released from its storage container as the carrying gas flow starts to inflate the balloon. In Block 308, a command is sent by the PLC to the electrical winch to release the winch line and elevate the balloon with the signal booster to a preset height (e.g., 50 meters). In Block 309, the signal booster starts to access and re-broadcast weak telecommunication signals to enable telecommunication for the user's mobile device and the vehicle's AVL system.

In Block 310, it is determined using the PLC whether any telecommunication signals are present. If the telecommunication signals are not present, the workflow returns to Block 309 where the signal booster continues to re-broadcast weak telecommunication signals. If the telecommunication signals are present, the workflow proceeds to Block 311 where the PLC automatically sends a message to the emergence respond unit to declare the emergence case including its current GPS location. In Block 312, it is determined whether the emergency case has ended to proceed with ballon retrieval and reset the system. For example, if the user's acknowledge message to end the emergency case is not received within a preset time period (e.g., 10 minutes), the workflow returns to Block 309 to check the re-broadcasted telecommunication signals. If the user's acknowledge message is received within the preset time period, the PLC sends a command to retrieve the balloon in Block 313, and the workflow returns to Block 301 where the PLC continues the telecommunication signal monitoring.

Embodiments may be implemented on a computer system. FIG. 4 is a block diagram of a computing system (400) used to provide computational functionalities associated with described algorithms, methods, functions, processes, flows, and procedures as described in the instant disclosure, according to an implementation. The illustrated computer (402) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (402) may include a computer that includes an input device, such as a keypad, keyboard, touch screen, or other device that can accept user information, and an output device that conveys information associated with the operation of the computer (402), including digital data, visual, or audio information (or a combination of information), or a GUI.

The computer (402) can serve in a role as a client, network component, a server, a database or other persistency, or any other component (or a combination of roles) of a computer system for performing the subject matter described in the instant disclosure. The illustrated computer (402) is communicably coupled with a network (430). In some implementations, one or more components of the computer (402) may be configured to operate within environments, including cloud-computing-based, local, global, or other environment (or a combination of environments).

At a high level, the computer (402) is an electronic computing device operable to receive, transmit, process, store, or manage data and information associated with the described subject matter. According to some implementations, the computer (402) may also include or be communicably coupled with an application server, e-mail server, web server, caching server, streaming data server, business intelligence (BI) server, or other server (or a combination of servers).

The computer (402) can receive requests over network (430) from a client application (for example, executing on another computer (402)) and responding to the received requests by processing the said requests in an appropriate software application. In addition, requests may also be sent to the computer (402) from internal users (for example, from a command console or by other appropriate access method), external or third-parties, other automated applications, as well as any other appropriate entities, individuals, systems, or computers.

Each of the components of the computer (402) can communicate using a system bus (403). In some implementations, any or all of the components of the computer (402), both hardware or software (or a combination of hardware and software), may interface with each other or the interface (404) (or a combination of both) over the system bus (403) using an application programming interface (API) (412) or a service layer (413) (or a combination of the API (412) and service layer (413). The API (412) may include specifications for routines, data structures, and object classes. The API (412) may be either computer-language independent or dependent and refer to a complete interface, a single function, or even a set of APIs. The service layer (413) provides software services to the computer (402) or other components (whether or not illustrated) that are communicably coupled to the computer (402). The functionality of the computer (402) may be accessible for all service consumers using this service layer. Software services, such as those provided by the service layer (413), provide reusable, defined business functionalities through a defined interface. For example, the interface may be software written in JAVA, C++, or other suitable language providing data in extensible markup language (XML) format or other suitable format. While illustrated as an integrated component of the computer (402), alternative implementations may illustrate the API (412) or the service layer (413) as stand-alone components in relation to other components of the computer (402) or other components (whether or not illustrated) that are communicably coupled to the computer (402). Moreover, any or all parts of the API (412) or the service layer (413) may be implemented as child or sub-modules of another software module, enterprise application, or hardware module without departing from the scope of this disclosure.

The computer (402) includes an interface (404). Although illustrated as a single interface (404) in FIG. 4, two or more interfaces (404) may be used according to particular needs, desires, or particular implementations of the computer (402). The interface (404) is used by the computer (402) for communicating with other systems in a distributed environment that are connected to the network (430). Generally, the interface (404) includes logic encoded in software or hardware (or a combination of software and hardware) and operable to communicate with the network (430). More specifically, the interface (404) may include software supporting one or more communication protocols associated with communications such that the network (430) or interface's hardware is operable to communicate physical signals within and outside of the illustrated computer (402).

The computer (402) includes at least one computer processor (405). Although illustrated as a single computer processor (405) in FIG. 4, two or more processors may be used according to particular needs, desires, or particular implementations of the computer (402). Generally, the computer processor (405) executes instructions and manipulates data to perform the operations of the computer (402) and any algorithms, methods, functions, processes, flows, and procedures as described in the instant disclosure.

The computer (402) also includes a memory (406) that holds data for the computer (402) or other components (or a combination of both) that can be connected to the network (430). For example, memory (406) can be a database storing data consistent with this disclosure. Although illustrated as a single memory (406) in FIG. 4, two or more memories may be used according to particular needs, desires, or particular implementations of the computer (402) and the described functionality. While memory (406) is illustrated as an integral component of the computer (402), in alternative implementations, memory (406) can be external to the computer (402).

The application (407) is an algorithmic software engine providing functionality according to particular needs, desires, or particular implementations of the computer (402), particularly with respect to functionality described in this disclosure. For example, application (407) can serve as one or more components, modules, applications, etc. Further, although illustrated as a single application (407), the application (407) may be implemented as multiple applications (407) on the computer (402). In addition, although illustrated as integral to the computer (402), in alternative implementations, the application (407) can be external to the computer (402).

There may be any number of computers (402) associated with, or external to, a computer system containing computer (402), each computer (402) communicating over network (430). Further, the term “client,” “user,” and other appropriate terminology may be used interchangeably as appropriate without departing from the scope of this disclosure. Moreover, this disclosure contemplates that many users may use one computer (402), or that one user may use multiple computers (402).

In some embodiments, the computer (402) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Embodiments described above have the following attributes and advantages:
(i) Multifunctional & mobile telecommunication tower which can serve as an emergency beacon;
(ii) Improve telecommunication coverage by providing AVL system receivers and user's mobile device access to high elevation signal booster thus establishes line of sight and connection with the remote telecommunication tower;
(iii) Automatically detect emergency situation and subsequently activate the emergency rescue sequence to rescue unconscienced victims;
(iv) Flexible logic control through a PLC;
(v) Automatic emergency detection and activation of emergency rescue sequence; and
(vi) Reflective balloon coating to serve as emergency beacon to guide rescuers to the emergency location.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method for boosting telecommunication signals, comprising:
disposing a signal booster in a location where the telecommunication signals are intermittent or below a pre-determined threshold;
monitoring the telecommunication signals in the location;
detecting, in response to said monitoring and based at least on a status of the monitored telecommunication signals, a pre-determined adverse event;
elevating, using air lift and in response to said detecting the pre-determined adverse event, the signal booster to an elevated height;
receiving and re-broadcasting, by the signal booster from the elevated height, the telecommunication signals; and
mitigating, based at least on the re-broadcasted telecommunication signals, the pre-determined adverse event.

2. The method of claim 1, said disposing the signal booster in the location comprising:
disposing an automatic airborne remote area emergency system in a vehicle, the location being in a remote area where the vehicle is travelling,
wherein the automatic airborne remote area emergency system comprises an airborne component that carries the signal booster using the air lift.

3. The method of claim 2,
wherein the airborne component comprises a balloon or a drone.

4. The method of claim 2, said monitoring the telecommunication signals in the location comprising:
retrieving, using a controller of the automatic airborne remote area emergency system and via an on-board diagnostic (OBD) port of the vehicle, the status of the monitored telecommunication signals from an automatic vehicle locating (AVL) system on the vehicle.

5. The method of claim 2, said elevating the signal booster comprising:
opening, in response to said detecting the pre-determined adverse event, a solenoid valve to conduct a flow of carrying gas from a storage tank on the vehicle, wherein the airborne component comprises a balloon that is stowed in a storage container on the vehicle;
releasing, in response to said detecting the pre-determined adverse event and using an electric winch on the vehicle, the balloon from the storage container;
inflating, by the flow of carrying gas, the balloon; and
releasing, by the electric winch, a winch line attached to the balloon to allow the balloon to elevate to the elevated height.

6. The method of claim 5, said mitigating the pre-determined adverse event comprising:
transmitting, based at least on the re-broadcasted telecommunication signals, a request for emergency response to an emergency response unit;
dispatching, in response to the request, an emergency response personnel to the remote area; and
providing, based at least on a reflective coating on the balloon at the elevated height, visual guidance to the emergency response personnel to locate the vehicle in the remote area.

7. The method of claim 1,
wherein the telecommunication signals comprise a cellular signal and a global positioning service (GPS) signal.

8. A system for boosting telecommunication signals, comprising:
a signal booster disposed in a location where the telecommunication signals are intermittent or below a pre-determined threshold;
a controller that:
monitors the telecommunication signals in the location; and
detects, in response to said monitoring and based at least on a status of the monitored telecommunication signals, a pre-determined adverse event; and
an airborne component that carries, using air lift and in response to said detecting the pre-determined adverse event, the signal booster to an elevated height,
wherein the signal booster receives and re-broadcasts the telecommunication signals from the elevated height, and
wherein the pre-determined adverse event is mitigated based at least on the re-broadcasted telecommunication signals.

9. The system of claim 8,
wherein the signal booster, the controller, and the airborne component are disposed in a vehicle, the location being in a remote area where the vehicle is travelling.

10. The system of claim 8,
wherein the airborne component comprises a balloon or a drone.

11. The system of claim 9,
wherein the controller retrieves, via an on-board diagnostic (OBD) port of the vehicle, the status of the monitored telecommunication signals from an automatic vehicle locating (AVL) system on the vehicle.

12. The system of claim 9, further comprising:
a solenoid valve that is opened, by the controller and in response to said detecting the pre-determined adverse event, to conduct a flow of carrying gas from a storage tank on the vehicle, wherein the airborne component comprises a balloon that is stowed in a storage container on the vehicle; and
an electric winch on the vehicle that is activated, by the controller and in response to said detecting the pre-determined adverse event, to release the balloon from the storage container,
wherein the balloon is inflated by the flow of carrying gas and is allowed to elevate to the elevated height by the electric winch releasing a winch line attached to the balloon.

13. The system of claim 12, said mitigating the pre-determined adverse event comprising:
transmitting, based at least on the re-broadcasted telecommunication signals, a request for emergency response to an emergency response unit;
dispatching, in response to the request, an emergency response personnel to the remote area; and
providing, based at least on a reflective coating on the balloon at the elevated height, visual guidance to the emergency response personnel to locate the vehicle in the remote area.

14. The system of claim 8,
wherein the telecommunication signals comprise a cellular signal and a global positioning service (GPS) signal.

15. A vehicle for traveling in a remote area, comprising:
an automatic airborne remote area emergency system comprising:
a signal booster that receives and re-broadcast telecommunication signals that are intermittent or below a pre-determined threshold in the remote area;
a controller that:
monitors the telecommunication signals; and
detects, in response to said monitoring and based at least on a status of the monitored telecommunication signals, a pre-determined adverse event; and
an airborne component that carries, using air lift and in response to said detecting the pre-determined adverse event, the signal booster to an elevated height,
wherein the signal booster receives and re-broadcasts the telecommunication signals from the elevated height, and
wherein the pre-determined adverse event is mitigated based at least on the re-broadcasted telecommunication signals.

16. The vehicle of claim 15,
wherein the airborne component comprises a balloon or a drone.

17. The vehicle of claim 15, further comprising:
an on-board diagnostic (OBD) port; and
an automatic vehicle locating (AVL) system,
wherein the controller retrieves, via the OBD port, the status of the monitored telecommunication signals from the AVL system.

18. The vehicle of claim 15, further comprising:
a storage container that stows a balloon of the airborne component;
a storage tank that stores carrying gas; and
an electrical winch that releases and retrieves a winch line attached to the balloon, the automatic airborne remote area emergency system further comprising:
a solenoid valve that is opened, by the controller and in response to said detecting the pre-determined adverse event, to conduct the flow of carrying gas from the storage tank,
wherein the electric winch is activated, by the controller and in response to said detecting the pre-determined adverse event, to release the balloon from the storage container, and
wherein the balloon is inflated by the flow of carrying gas and is allowed to elevate to the elevated height by the electric winch releasing the winch line.

19. The vehicle of claim 18, said mitigating the pre-determined adverse event comprising:
transmitting, based at least on the re-broadcasted telecommunication signals, a request for emergency response to an emergency response unit;
dispatching, in response to the request, an emergency response personnel to the remote area; and
providing, based at least on a reflective coating on the balloon at the elevated height, visual guidance to the emergency response personnel to locate the vehicle in the remote area.

20. The vehicle of claim 15,
wherein the telecommunication signals comprise a cellular signal and a global positioning service (GPS) signal.
